(19) United States
(12) Patent Application Publication
(10) Pub. No.: US 2026/0194436 A1
(43) Pub. Date: Jul. 9, 2026

(54) PARTICLE MEASURING DEVICE AND PARTICLE MEASURING METHOD

(71) Applicant: RION CO., LTD., Tokyo (JP)

(72) Inventors: Tomonobu MATSUDA, Kokubunji-shi, Tokyo (JP); Daisuke SHINOZAKI, Kokubunji-shi, Tokyo (JP)

(21) Appl. No.: 19/130,782

(22) PCT Filed: Nov. 17, 2023
(86) PCT No.: PCT/JP2023/041413

§ 371 Date: May 16, 2025

(30) Foreign Application Priority Data
Nov. 18, 2022 (JP) 2022-184929

(51) Int. Cl. G01N 15/0205

(52) U.S. Cl. CPC G01N 15/0211

(57) ABSTRACT

In a particle measuring device, an irradiation optical system and a light-receptive optical system are fixed to a stage, and when the stage is moved in a predetermined direction on a plane, the entire system moves in the predetermined direction, while a flow cell fixed to a base does not move. Therefore, the irradiation optical system and the light-receptive optical system can be moved in the predetermined direction while maintaining a relationship of a relative position therebetween, and it allows a position where irradiation light enters the flow cell to be changed. As a result, a position of an observation area, which is a irradiation position of the irradiation light, with respect to a flow passage extending from an inlet to an outlet can be adjusted, and it is capable of scanning over a wide area. Accordingly, particles contained in a sample fluid can be accurately measured.

### TECHNICAL FIELD

The present invention relates to a device that measures particles contained in a sample fluid and a method thereof.

### BACKGROUND ART

Generally, particles contained in a sample fluid are measured by emitting light onto a flow cell having a flow passage formed therein, and receiving light scattered by the particles in the sample fluid flowing through the flow passage. As one of these techniques, there is a method that involves observing a particle observation area formed in a part of a flow passage when irradiation light is incident thereon, and estimating the number of particles contained in an entire sample based on measurement values in the observation area (see, for example, Patent Literature 1).

### CITATION LIST

### Patent Literature

Patent Literature 1: JP5859154B

### SUMMARY OF INVENTION

### Technical Problem

In the technique described above, the particles are not necessarily uniformly distributed in the sample fluid, but the irradiation area of the irradiation light (the particle observation area) is limited to a partial area near the center of the entire flow passage. Therefore, especially when measuring an extremely small number of particles, the total number of particles statistically estimated based on the measurement values in the observation area may differ significantly from the actual number of particles.

Meanwhile, with advances in semiconductor and other techniques, there is a growing demand for measuring smaller particles with higher reliability. In order to measure smaller particles, possible measures include increasing the sensitivity of a light-receptive optical system or increasing the output of a light source to increase the intensity (energy density) of the irradiation light in the observation area. However, these measures have performance limitations due to the components used.

The present invention has been made in view of these problems, and an object of the present invention is to provide a technique of accurately measuring particles contained in a sample fluid.

### Solution to Problem

In order to solve the above problem, the present invention adopts the following particle measuring device and particle measuring method. The descriptions in parentheses below are merely examples, and the present invention is not limited thereto.

That is, the particle measuring device and the particle measuring method according to the present invention are to measure particles by using: a flow cell having a flow passage into which a sample fluid is introduced; an irradiation optical system including a light source emitting irradiation light, and configured to irradiate the flow passage with the irradiation light; and a light-receptive optical system configured to receive scattered light generated from particles contained in the sample fluid in an observation area formed in a part of the flow passage by irradiating the flow passage with the irradiation light. The irradiation optical system and the light-receptive optical system are disposed on one or more stages. A flow of the sample fluid in the flow passage can be adjusted by a variable flow-rate mechanism.

In the particle measuring device and the particle measuring method according to the present invention, by moving the stage, it is possible to move the observation area and scan the flow passage while maintaining a relationship of a relative position between the irradiation optical system and the light-receptive optical system, and particles are counted by particle size based on intensity of the scattered light received in the observation area.

According to the particle measuring device and the particle measuring method of the aspect, an irradiation position of the irradiation light with respect to the flow passage can be changed while maintaining the relationship of the relative position between the irradiation optical system and the light-receptive optical system, and thus it becomes possible to receive the scattered light from the particles in the moving observation area. This allows particle measurement to be performed over a wide area in the flow passage, making it possible to perform highly accurate measurement even when the particle distribution in the sample fluid is uneven or when the number of particles is extremely small.

Preferably, in the particle measuring device and the particle measuring method according to the above aspect, the flow of the sample fluid is stopped or lowered before starting measurement.

According to the particle measuring device and the particle measuring method of the aspect, particles can be measured in a state where the sample fluid is stored in the flow passage or in a state where the sample fluid flows at a speed sufficiently slow with respect to the measurement time. This makes it possible to increase the light reception sensitivity of the scattered light, thereby enabling the measurement of smaller particles. In addition, comprehensive measurement of the same sample fluid can be performed, thereby reducing the number of particles that go unnoticed. Therefore, according to the particle measuring device and particle measuring method of the aspect, the accuracy of particle measurement can be further improved.

Preferably, in the particle measuring device and the particle measuring method according to the above aspect, control is executed to terminate the measurement midway or to change a flow speed of the sample fluid, depending on the number of particles per unit volume of the sample fluid (hereinafter, referred to as “particle concentration”) during the execution of the measurement.

According to the particle measuring device and the particle measuring method of the aspect, for example, when the particle concentration exceeds a predetermined threshold, the particle concentration is considered to be sufficient for measurement, and the measurement can be terminated midway, thereby shortening the measurement time. In addition, for example, when the particle concentration exceeds the predetermined threshold, the flow speed of the sample fluid can be increased. Alternatively, when the particle concentration is equal to or less than the predetermined threshold, the flow speed of the sample fluid can be decreased. Therefore, measurement accuracy can be ensured regardless of the particle concentration.

More preferably, in the particle measuring device and the particle measuring method according to the above aspect, the irradiation position is moved along a pattern for continuously moving the irradiation position between a start position and an end position set within the flow passage, and the scattered light is received in the observation area formed in a continuous area between the start position and the end position as the irradiation position moves. Alternatively, in the particle measuring device and the particle measuring method according to the above aspect, the irradiation position is moved along a pattern for intermittently moving the irradiation position to a plurality of discontinuous positions set within the flow passage, and the scattered light is received in the observation area formed at the plurality of discontinuous positions as the irradiation position moves.

According to the particle measuring device and the particle measuring method of the aspect, when measuring particles over a wide area in the flow passage, the optimal pattern can be selected based on the properties and tendencies of the sample fluid, thereby enabling efficient particle measurement. For example, when the number of particles contained in the sample fluid is extremely small, by performing the measurement over a continuous area from the start position to the end position, it is possible to reduce the number of particles that go unnoticed and improve the measurement accuracy. Meanwhile, when the number of particles is not particularly small, the measurement time can be shortened by performing the measurement in a plurality of areas formed at discontinuous positions.

Still more preferably, in the particle measuring device and the particle measuring method according to the aspect, the irradiation position is moved along the above pattern a plurality of times, and the scattered light is received a plurality of times in the observation area formed as the irradiation position moves. In addition, when the irradiation position is moved along the pattern a plurality of times, the irradiation position is moved along the pattern in a predetermined direction at an odd-numbered time, and the irradiation position is moved along the pattern in a direction opposite to the predetermined direction at an even-numbered time.

According to the particle measuring device and the particle measuring method of this aspect, since measurement can be performed a plurality of times on the same area, it is possible to improve the reliability of the measurement results. In addition, by reversing the movement direction between the odd-numbered measurement and the even-numbered measurement, movement and measurement can be performed simultaneously. Accordingly, the time spent just on movement can be minimized, thereby shortening the time required for the entire measurement.

### Advantageous Effects of Invention

As described above, according to the particle measuring device and particle measuring method of the present invention, the particles contained in the sample fluid can be accurately measured.

### BRIEF DESCRIPTION OF DRAWINGS

FIG. 1 is a perspective view schematically illustrating a particle measuring device 100 according to a first embodiment.

FIG. 2 is a plan view schematically illustrating the particle measuring device 100.

FIG. 3 is a vertical cross-sectional view (cross-sectional view taken along line III-III in FIG. 2) illustrating a positional relation between a flow cell 110 and a light-receptive optical system 140.

FIG. 4A is a diagram illustrating a scanning method.

FIG. 4B is a diagram illustrating a scanning method.

FIG. 4C is a diagram illustrating a scanning method.

FIG. 5A is a diagram illustrating a modification of the scanning method.

FIG. 5B is a diagram illustrating a modification of the scanning method.

FIG. 6 is a perspective view schematically illustrating a modification of the particle measuring device 100.

FIG. 7 is a functional block diagram illustrating a configuration of the particle measuring device 100.

FIG. 8 is a perspective view schematically illustrating a particle measuring device 200 according to a second embodiment.

FIG. 9 is a plan view schematically illustrating the particle measuring device 200.

FIG. 10 is a perspective view schematically illustrating a particle measuring device 300 according to a third embodiment.

FIG. 11 is a plan view schematically illustrating the particle measuring device 300.

### DESCRIPTION OF EMBODIMENTS

Hereinafter, an embodiment of the present invention will be described with reference to the drawings. In order to facilitate understanding of the invention, shapes of components constituting the particle measuring device are simplified and dimensions thereof are exaggerated in the drawings, and some components are omitted from illustration.

### First Embodiment

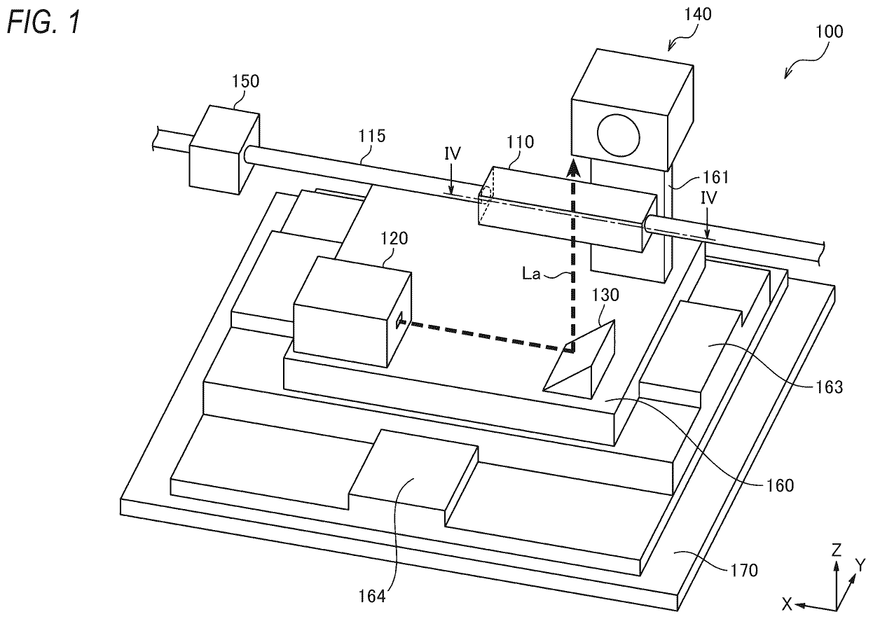

FIG. 1 is a perspective view schematically illustrating a particle measuring device 100 according to a first embodiment.

The particle measuring device 100 includes a flow cell 110, an irradiation optical system (in the illustrated example, a light source 120 and a mirror 130), and a light-receptive optical system 140, as a configuration for detecting particles contained in a sample fluid.

The flow cell 110 is made of a crystalline material such as synthetic corundum, and has a flow passage formed therein into which the sample fluid is introduced. The flow cell 110 and pipes connected thereto are supported by a flow cell rack (not illustrated), and are indirectly fixed to a base 170 via the flow cell rack. In the following description, a direction in which the flow passage of flow cell 110 extends is referred to as an “X direction”.

The light source 120 emits irradiation light La (for example, laser light) of a predetermined wavelength in the X direction with a divergence angle within a range that can be considered parallel. The mirror 130 reflects the irradiation light La emitted from the light source 120 toward the flow cell 110. Accordingly, the irradiation light La is incident on the flow cell 110 and irradiates an observation area set in a part of the flow passage.

When particles contained in the sample fluid are present within the observation area, scattered light is generated when the particles are irradiated with the irradiation light La. The scattered light from the particles generated in this way is received by the light-receptive optical system 140, which includes a lens and a light-receptive element. The light-receptive optical system 140 is disposed so that a central axis thereof is orthogonal to the X direction. The reception of scattered light will be described further below using another drawing. In the following description, the direction of the central axis of the light-receptive optical system is referred to as a “Y direction”, and the direction orthogonal to both the X direction and the Y direction is referred to as a “Z direction”.

A variable flow-rate mechanism 150 is provided in a downstream pipe 115 connected to the flow cell 110. The variable flow-rate mechanism 150 is capable of adjusting the flow (flow speed) of the sample fluid by changing the flow rate. The variable flow-rate mechanism 150 is also capable of stopping the flow of the sample fluid or lowering the flow of the sample fluid so that the sample fluid flows at a speed sufficiently slow with respect to the measurement time. The variable flow-rate mechanism 150 includes a detection part, thereby enabling feedback control while monitoring the flow rate. In the illustrated example, the variable flow-rate mechanism 150 is provided on the downstream pipe 115, but instead the variable flow-rate mechanism 150 may be provided near an outlet of the sample fluid in the flow cell 110.

In the particle measuring device 100, the light source 120 and the mirror 130 are fixed to a stage 160, and the light-receptive optical system 140 is also fixed to the stage 160 via a stand 161. The particle measuring device 100 includes an X-axis slider 163 for moving the stage 160 in the X direction, and a Y-axis slider 164 for moving the stage 160 in the Y direction, and the stage 160 is movable in the X direction and the Y direction. The X-axis slider 163 and the Y-axis slider 164 are implemented using, for example, actuators.

In the illustrated example, the stage 160 is provided on the X-axis slider 163, the X-axis slider 163 is provided on the Y-axis slider 164, and the Y-axis slider 164 is fixed to the base 170. The X-axis slider 163 can slide and move the stage 160 in the X direction, and the Y-axis slider 164 can slide and move the stage 160 together with the X-axis slider 163 in the Y direction. The Y-axis slider 164 may be configured to move only the stage 160 in the Y direction.

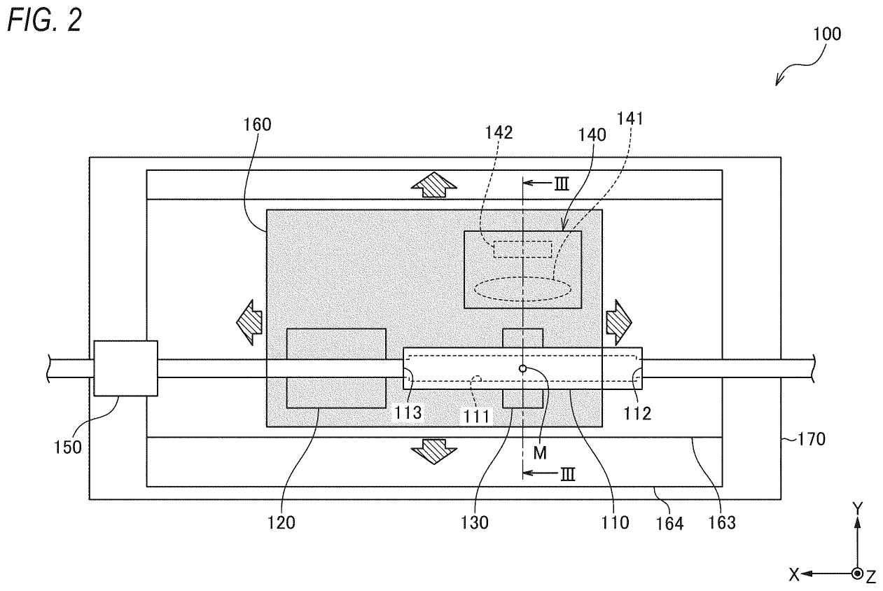

FIG. 2 is a plan view schematically illustrating the particle measuring device 100.

In the particle measuring device 100, the flow cell 110 is fixed to the base 170, whereas the irradiation optical system (light source 120, mirror 130) and the light-receptive optical system 140 (lens 141, light reception element 142) are fixed to the stage 160. Therefore, by moving the stage 160 in the X direction or the Y direction, the entire portion shaded to be in mid-color between white and black in the figure moves in the X direction or the Y direction, so that the irradiation optical system and the light-receptive optical system 140 can be moved in the X direction or the Y direction while maintaining the relationship of the relative position therebetween.

Due to the configuration, the particle measuring device 100 can change the position at which the irradiation light La is incident on the flow cell 110 while maintaining the relationship of the relative position between the irradiation optical system and the light-receptive optical system. This makes it possible to measure particles over a wide area in a flow passage 111 while moving the irradiation position of the irradiation light La (in other words, a formation position of an observation area M) with respect to the flow passage 111 extending from an inlet 112 to an outlet 113 of the flow cell. In the following description, measuring particles in this manner is referred to as “scanning”.

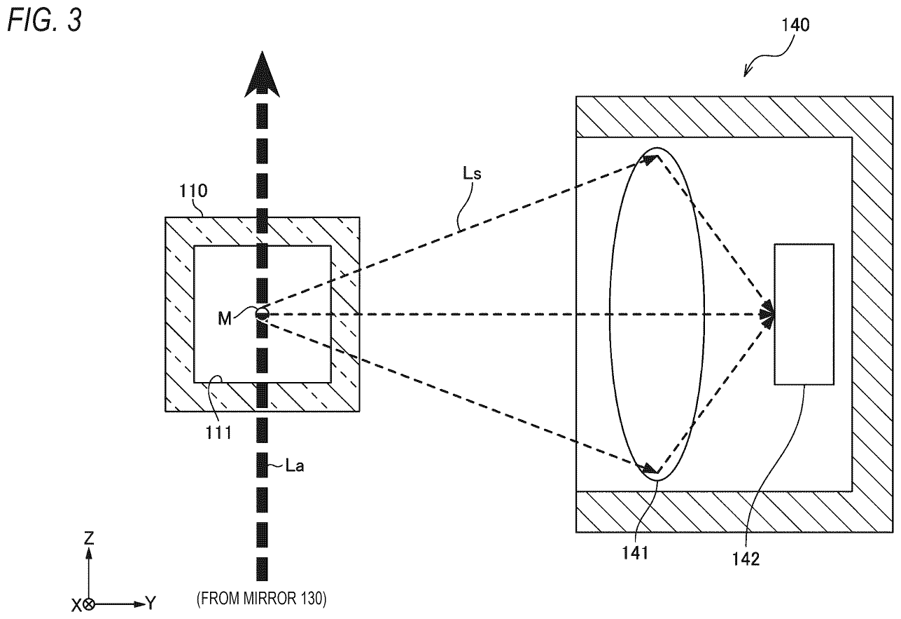

FIG. 3 is a vertical cross-sectional view (cross-sectional view taken along line III-III in FIG. 2) illustrating a positional relation between the flow cell 110 and the light-receptive optical system 140.

For example, when the observation area M is set approximately at the center of the flow passage 111 in the Y direction, the movement of the stage 160 is controlled so that the irradiation light La reflected by the mirror 130 irradiates this position. The irradiation light La enters the flow cell 110, passes through the observation area M, and then exits to the outside of the flow cell 110. From another perspective, it can also be considered that the irradiation position of the irradiation light La with respect to the flow passage 111 is first set, and then the observation area M is formed at a corresponding position within the flow passage 111.

When particles are present in the observation area M, scattered light is generated by the interaction between the particles and the irradiation light La, and side scattered light Ls is received by the light-receptive optical system 140. Specifically, the side scattered light Ls from the particles is collected by the lens 141, received by the light reception element 142 (for example, a photodiode), and converted into an electrical signal corresponding to its intensity. The converted electrical signal is sent to a control unit (not illustrated in FIG. 3), and the size and number of the particles are measured based on the magnitude of the electrical signal, that is, the intensity of the received scattered light.

A structure (for example, a concave portion or a convex lens) that assists in collecting the side scattered light Ls may be provided on a wall surface of the flow cell 110 through which the side scattered light Ls passes. An internal configuration of the control unit will be described in detail later with reference to another drawing.

### [Scanning Method]

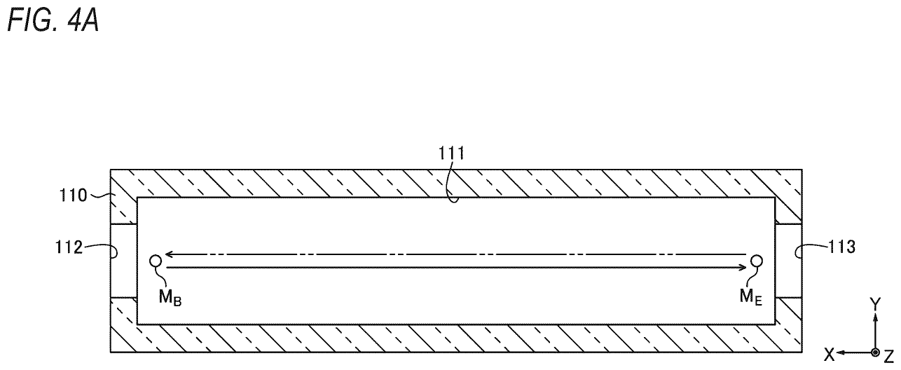

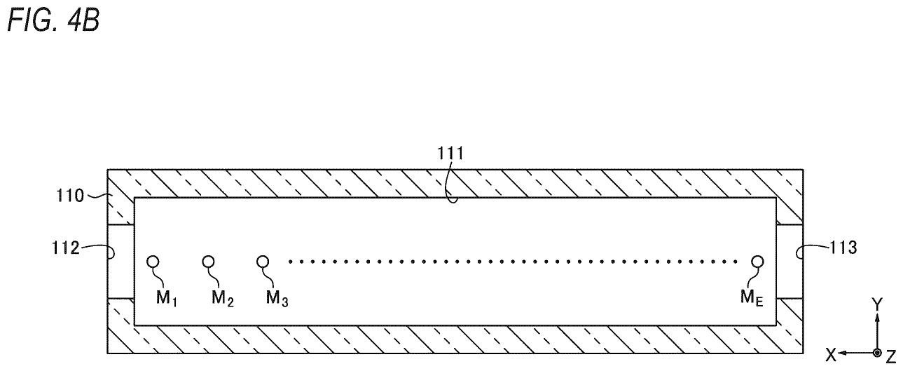

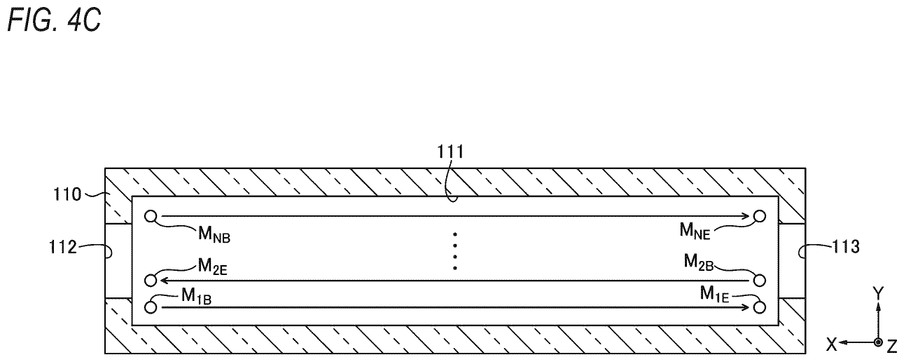

FIG. 4A, FIG. 4B, and FIG. 4C are diagrams illustrating three methods of scanning a sample fluid in the flow passage 111, using a horizontal cross-sectional view of the flow cell 110 (a cross-sectional view taken along a line IV-IV in FIG. 1). In any of the methods, scanning is performed in a state where the flow of the sample fluid is stopped and the sample fluid is stored in the flow passage 111. In addition, patterns regarding the set position of the observation area M (irradiation position of the irradiation light La), corresponding to the methods illustrated in FIG. 4A, FIG. 4B, and FIG. 4C, are predetermined. The particle measuring device 100 irradiates the set observation area M with the irradiation light La and moves the stage 160 (in other words, the irradiation optical system and the light-receptive optical system) according to the pattern so as to receive scattered light generated in the observation area M, thereby moving the irradiation position of the irradiation light La to perform measurement.

FIG. 4A: In a first scanning method, the particle measuring device 100 sets the irradiation position of the irradiation light La (the position of the observation area M) with respect to the flow passage 111 between two separate positions in the flow passage 111 of the flow cell (for example, positions on one end side and the other end side of the flow passage 111). The particle measuring device 100 performs measurement while continuously moving the irradiation position in the X direction. For example, along a predetermined pattern, an observation area MB is set with a position closer to the inlet 112 of the flow cell as the start position, and an observation area ME is set with a position closer to the outlet 113 as the end position. The particle measuring device 100 continuously measures the area from the observation area MB to the observation area ME while moving the stage 160 in the X direction so that the observation area M moves from the start position to the end position.

Once the measurement of the area from the observation area MB to the observation area ME is completed, the measurement may be terminated at that point, or the stage 160 may be moved in a direction opposite to that of the previous measurement to measure the same area as the previous measurement again, or the measurement may be repeated a plurality of times by moving the stage 160 back and forth between the start position and the end position. When the same area is measured a plurality of times, it is possible to output the average, mode, maximum, minimum, and other values each time the measurement is performed as measurement results.

FIG. 4B: In a second scanning method, the particle measuring device 100 discretely sets the irradiation position of the irradiation light La (position of the observation area M) with respect to the flow passage 111 in the X direction and performs measurement. For example, along a predetermined pattern, a position closer to the inlet 112 of the flow cell is set as the start position and a position closer to the outlet 113 is set as the end position. The particle measuring device 100 sets observation areas M₁, M₂, M₃, . . . , ME at predetermined intervals between the start position and the end position. Then, the particle measuring device 100 measures the observation area M₁ first and ends this measurement. The stage 160 is then moved in the X direction to align with the next observation area M₂. The observation area M₂ is measured, and once this measurement is completed, the stage 160 is moved in the X direction to align with the next observation area M₃. Then, the observation area M₃ is measured. In this way, the particle measuring device 100 measures the plurality of discretely set observation areas M₁ to ME in order.

Once the plurality of observation areas M₁ to ME have been measured, the measurement may be terminated at that point, or the stage 160 may be moved in a direction opposite to that of the previous measurement to measure the same areas as the previous measurement again in the order of observation areas M_{E}, . . . , M₂, M₁, or the measurement may be repeated a plurality of times back and forth for the plurality of observation areas M₁ to M_{E}. When the same area is measured a plurality of times, it is possible to output the average, mode, maximum, minimum, and other values each time the measurement is performed as measurement results. When the measurement is performed a plurality of times, the number of times of measurement for each observation area may be the same or different. For example, a particularly important observation area may be measured more times than the other observation areas. The second scanning method may also be combined with the first method described above to perform measurement that combines continuous measurement and discrete measurement.

FIG. 4C: In a third scanning method, the particle measuring device 100 moves the irradiation position of the irradiation light La (position of the observation area M) with respect to the flow passage 111 not only in the X direction but also in the Y direction. In other words, measurement is performed across a plane. For example, first, along a predetermined pattern, an area ranging from an observation area MIB near the inlet 112 of the flow cell to an observation area MIE near the outlet 113 is targeted. The measurement is continuously performed while moving the stage 160 in the X direction (hereinafter, referred to as “measurement 1”), and after the measurement 1 is completed, the stage 160 is moved slightly in the Y direction. Next, the measurement is continuously performed while moving the stage 160 in a direction opposite to that of the previous measurement, targeting an area ranging from an observation area M_{2B} near the outlet 113 to an observation area M_{2E} near the inlet 112 (hereinafter referred to as “measurement 2”). After the measurement 2 is completed, the stage 160 is moved slightly in the Y direction to perform further measurement. In this way, by repeating the continuous measurement in the X direction while gradually changing the position in the Y direction, a wider area can be measured compared with the first and second methods described above.

In this way, the third scanning method combines the first method (continuous measurement in the X direction) with movement in the Y direction to expand the target scanning area, but it is also possible to combine the second method (discrete measurement in the X direction) with movement in the Y direction to expand the target scanning area. From another perspective, the third method can also be considered as a method of moving the stage 160 so that the irradiation light La draws a zigzag pattern across an XY plane.

As illustrated in FIG. 4C, in the above examples, the observation areas M are completely different between the measurement 1 and the measurement 2, that is, between two continuous measurements performed sequentially. However, a part of the observation areas M may be overlapped. In addition, although the stage 160 is moved in the Y direction after the continuous measurement in the X direction is completed, movement in the Y direction may also be performed during the measurement in the X direction, that is, at the same time as the stage 160 being moved in the X direction.

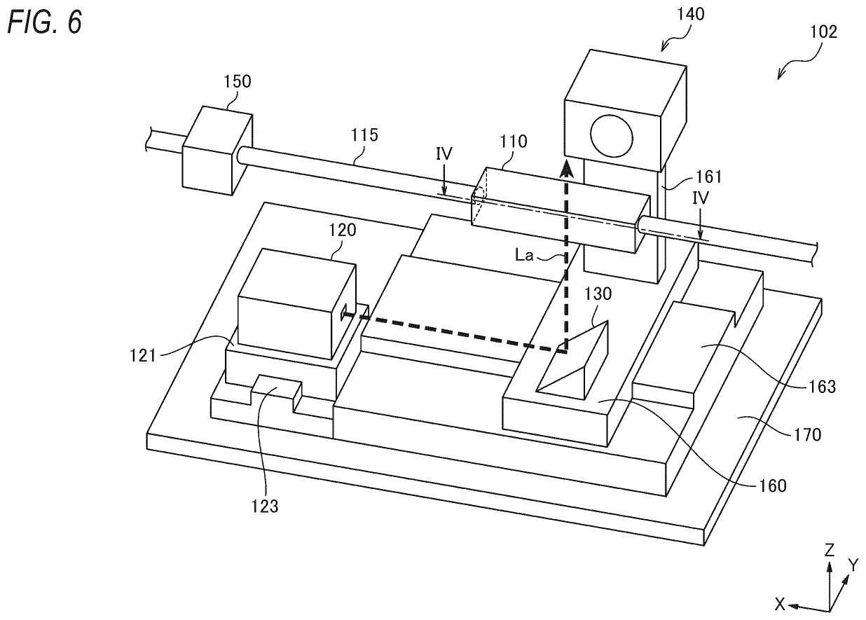

The arrangement of the irradiation optical system in the particle measuring device 100 may be slightly modified and implemented as in a particle measuring device 102 illustrated in FIG. 6. As compared with the particle measuring device 100 (FIG. 1), the modified particle measuring device 102 does not include the Y-axis slider 164, and the stage 160 is movable only in the X direction. In addition, the light source 120 is disposed on a stage 121 separate from the stage 160, and the stage 121 is provided on a Y-axis slider 123 and is movable only in the Y direction. In the particle measuring device 102, the irradiation position of the irradiation light La with respect to the flow passage 111 can be moved in the Y direction by moving the stage 121 in the Y direction, and can be moved in the X direction by moving the stage 160 in the X direction. Therefore, the particle measuring device 102 can also perform scanning using the first to third methods, similar to the particle measuring device 100.

Such an arrangement reduces a total weight of the components on the stage 160, thereby reducing the load on the X-axis slider 163 and lowering the performance requirements for the X-axis slider 163, making it possible to implement the particle measuring device using components with relatively lower performance.

However, if scanning using only the first or second method is sufficient and scanning using the third method is not performed, the Y-axis slider 123 is unnecessary. In this case, in the modified particle measuring device 102, the stage 121 may be fixed to the base 170, and the light source 120 may be fixed to the stage 121 with an emission port thereof facing a reflective surface of the mirror 130.

In the above examples, the particle measuring device 100 performs scanning in a state where the sample fluid is stored in the flow passage 111. Alternatively, the variable flow-rate mechanism 150 may be provided so that the sample fluid flows through the flow passage 111 at a speed that is sufficiently slow with respect to the measurement time (for example, 1 mL/min), and scanning may be performed after the flow speed is adjusted. In this case, once a series of measurement is completed using the methods described above, the variable flow-rate mechanism 150 can be operated as needed to introduce the next sample fluid to be measured, thereby allowing the measurement to continue.

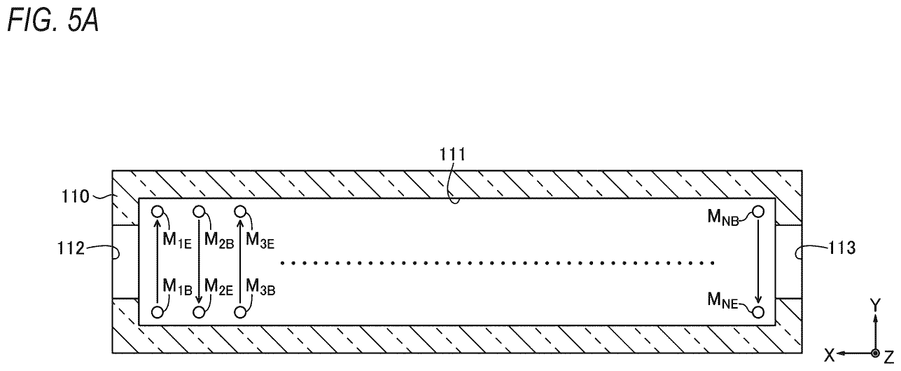

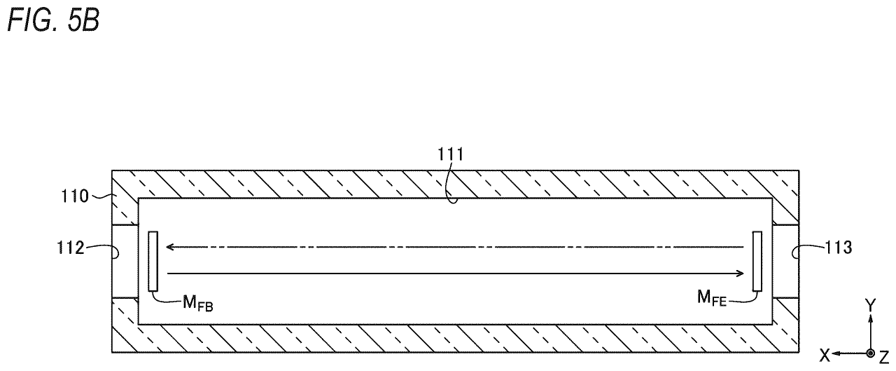

FIG. 5A and FIG. 5B are diagrams each illustrating a modification of the scanning method.

In the third scanning method described above, the particle measuring device 100 first performs measurement while moving the observation area M (the irradiation position of the irradiation light La) in the X direction, then slightly changes the position in the Y direction, and repeats the measurement while moving the observation area M again in the X direction. In this way, in the third method, the stage 160 is moved so that the trajectory of the movement of the observation area M during measurement is drawn along the X direction. Alternatively, as illustrated in FIG. 5A, the particle measuring device 100 may first perform measurement while moving the observation area M in the Y direction, then slightly change the position in the X direction, and repeat the measurement while moving the observation area M again in the Y direction, and this allows the stage 160 to be moved such that the trajectory of the observation area M during measurement is drawn along the Y direction of the flow passage 111.

In these three scanning methods described above, if a light source that emits sheet-shaped irradiation light La (with a cross-sectional shape such as circular or flattened) is used, the individual observation areas M can be set larger. Accordingly, in the first and second methods, a wider area can be measured without moving the observation area M in the Y direction. In the third method, a wider area can be measured while reducing the number of times of movements in the Y direction. For example, when the irradiation light La with a flattened cross-sectional shape is emitted toward the flow cell 110, the shape of the observation area M viewed from above also becomes flattened, as illustrated in FIG. 5B.

For example, an observation area M_{FB} is set with a position closer to the inlet 112 of the flow cell as the start position, and an observation area MFE is set with a position closer to the outlet 113 as the end position. Then, when an area from the observation area M_{FB} to the observation area MFE is continuously measured using a light source emitting the sheet-shaped irradiation light La while moving the stage 160 in the X direction so that the observation area M moves from the initial position to the final position, the movement mode of the stage is the same as that in the first method described above, but a wider area can be measured compared with the first method. If movement in the Y direction is combined with this measurement, the target scanning area can be further expanded. This makes it possible to measure an area equivalent to that of the third method described above with fewer movement times.

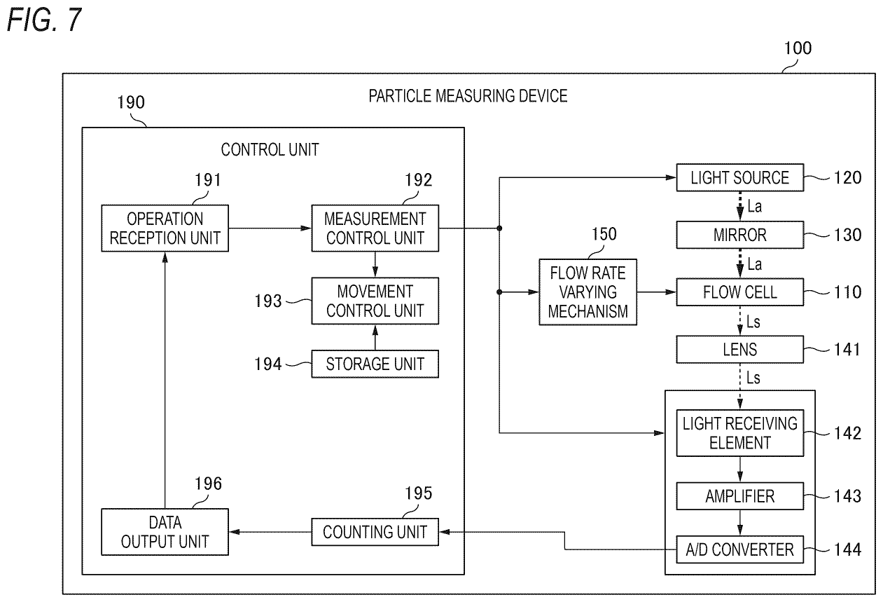

FIG. 7 is a functional block diagram illustrating the configuration of the particle measuring device 100.

In addition to the above components used for particle detection, the particle measuring device 100 includes a control unit 190. The control unit 190 includes, for example, an operation reception part 191, a measurement control part 192, a movement control part 193, a storage part 194, a counting part 195, and a data output part 196.

The operation reception part 191 provides an operation screen to a user and receives operations performed by the user via the operation screen. On the operation screen, the user can perform operations related to execution of measurement, selecting the flow speed of the sample fluid or scanning patterns, saving measurement results, and the like. Upon receiving an operation related to the execution of measurement, the operation reception part 191 instructs the measurement control part 192 to execute the measurement.

When an instruction to execute measurement is given, the measurement control part 192 first prepares for the measurement by switching the light source 120, the light reception element 142, an amplifier 143, and an A/D converter 144, which require power, to an operating state, and also operates the variable flow-rate mechanism 150 to cause the variable flow-rate mechanism 150 to adjust the flow speed of the sample fluid in the flow cell 110 to the selected flow speed. Instead of the measurement control part 192 operating the variable flow-rate mechanism 150 to adjust the flow speed, the user may directly operate the variable flow-rate mechanism 150 to adjust the flow speed.

When the measurement preparations are ready, the measurement control part 192 starts the measurement. Specifically, the measurement control part 192 instructs the movement control part 193 to control the operations of the X-axis slider 163 and the Y-axis slider 164. Upon receiving this instruction, the movement control part 193 acquires information about the selected scanning pattern from the storage part 194, controls the operations of the X-axis slider 163 and the Y-axis slider 164, and moves the stage 160 in a manner corresponding to the scanning pattern. As a result of the control executed by the movement control part 193, the irradiation position of the irradiation light La with respect to the flow passage of the flow cell (the position of the observation area M in the flow passage) moves along the selected scanning pattern.

The storage part 194 is a storage area that stores defined information for each scanning pattern in advance. For example, for the stage 160, the movement timing, movement direction, movement amount, and the like related to an X coordinate indicating the position with respect to the X-axis slider 163 and a Y coordinate indicating the position with respect to the Y-axis slider 164 are defined for each scanning pattern and stored in the storage part 194. The movement control part 193 controls the operations of the X-axis slider 163 and the Y-axis slider 164 based on these pieces of information, thereby moving the stage 160, and ultimately the irradiation position of the irradiation light La, along the scanning pattern.

The measurement control part 192 also controls the reception of the scattered light along the scanning pattern. When the measurement is started, the irradiation light La emitted from the light source 120 passes through the mirror 130 and enters the flow cell 110, irradiating the set observation area M. When particles contained in the sample fluid are present within the observation area M, the scattered light is generated when the particles are irradiated with the irradiation light La. This side scattered light Ls is collected by the lens 141 and incident on the light reception element 142 where the side scattered light Ls is received. The side scattered light Ls received by the light reception element 142 is converted into an electrical signal corresponding to its intensity. This electrical signal is amplified by the amplifier 143 at a predetermined gain, then converted into a digital signal by the A/D converter 144, and output to the counting part 195.

The counting part 195 determines the particle size based on the magnitude of the input digital signal, that is, the intensity of the received side scattered light Ls. Then, the counting part 195 counts the particles by particle size, compiles the measurement results, and outputs the measurement results to the data output part 196.

The measurement control part 192 can refer to a count value obtained by the counting part 195 in real time, and thus the measurement control part 192 can execute control based on the counting situation. For example, during executing the measurement, if a particle concentration (the number of particles per unit volume of the sample fluid) exceeds a predetermined threshold, it can be determined that the particle concentration is sufficient for the measurement. In that case, since the measurement accuracy can be sufficiently maintained even if the measurement is not performed to the end, the measurement control part 192 can terminate the measurement midway without executing the measurement to the end. By using such a control method, the time required for the entire measurement can be shortened. In addition, if the particle concentration exceeds the predetermined threshold, the measurement control part 192 can control the variable flow-rate mechanism 150 during the measurement to speed up (increase) the flow speed of the sample fluid, and if the particle concentration is equal to or less than the predetermined threshold, the measurement control part 192 can control the variable flow-rate mechanism 150 during the measurement to slow down (decrease) the flow speed of the sample fluid. According to such control, the measurement accuracy can be ensured regardless of the particle concentration.

The data output part 196 outputs data based on the measurement results output by the counting part 195. The data output may be displayed on a screen, printed, or transmitted to other devices via a network. Once the particle measurement is completed and the final data of the measurement results is ready, the final data can be saved. The data output part 196 notifies the operation reception part 191 that the final data is ready to be saved.

The control unit 190 may be provided integrally inside the particle measuring device 100, or may be provided outside the particle measuring device 100 and connected via a cable, a network, or the like.

### Second Embodiment

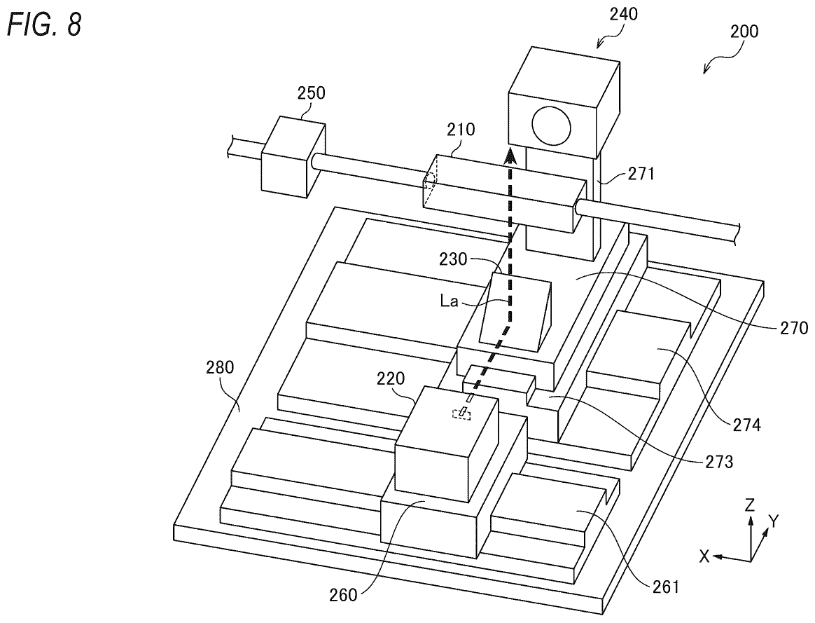

FIG. 8 is a perspective view schematically illustrating a particle measuring device 200 according to a second embodiment.

The particle measuring device 200 is particularly different from the particle measuring device 100 according to the first embodiment described above in that the light source is placed on a stage separate from the mirror and light-receptive optical system. In relation to these points, a path of the irradiation light La and a configuration of a slider also differ from those of the particle measuring device 100. Descriptions of points common to the first embodiment will be omitted.

In the particle measuring device 200, the irradiation light La is emitted from a light source 220 in the Y direction and is reflected by a mirror 230 toward a flow cell 210. Then, the irradiation light La is incident on the flow cell 210 and irradiates an observation area.

In the particle measuring device 200, the light source 220 is fixed to a first stage 260 that is movable only in the X direction. Meanwhile, the mirror 230 and a light-receptive optical system 240 are fixed to a second stage 270 that is movable in the X direction and the Y direction. Accordingly, the particle measuring device 200 includes an X-axis slider 261 for moving the first stage 260 in the X direction, as well as a Y-axis slider 273 for moving the second stage 270 in the Y direction and an X-axis slider 274 for moving the second stage 270 in the X direction.

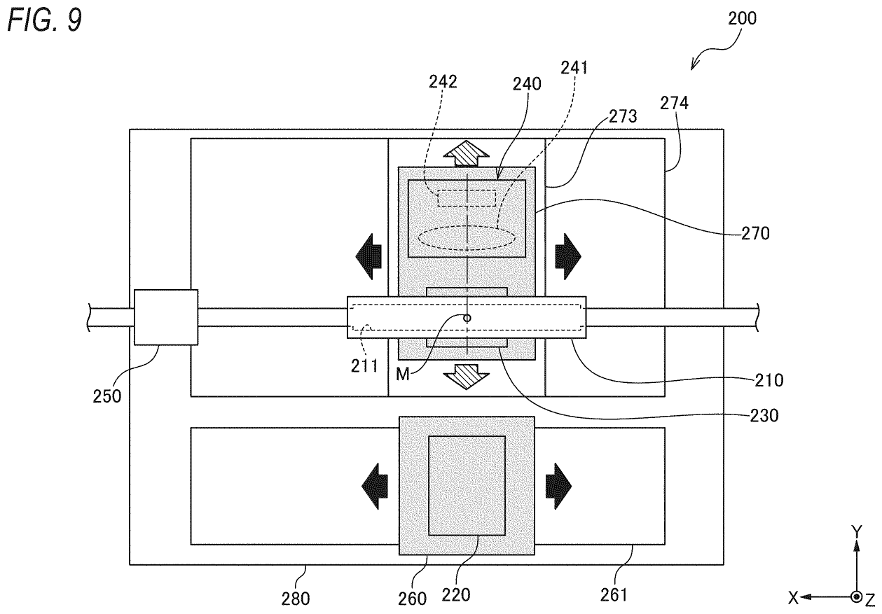

FIG. 9 is a plan view schematically illustrating the particle measuring device 200.

In particle measuring device 200, the first stage 260 to which light source 220 is fixed moves in conjunction with the second stage 270 to which the mirror 230 and the light-receptive optical system 240 (lens 241, light reception element 242) are fixed in the X direction. That is, the first stage 260 and the second stage 270 move synchronously in the directions indicated by the black arrows in the figure, and the entire portion shaded to be in mid-color between white and black in the figure moves in the X direction at the same time. Therefore, even if the first stage 260 and the second stage 270 move in the X direction, the relationship of the relative position between the irradiation optical system (light source 220, mirror 230) and the light-receptive optical system 240 is maintained.

In addition, when the second stage 270 is moved in the Y direction, a relative positional relation between the components constituting the irradiation optical system (between the light source 220 and the mirror 230) changes, but if the entire irradiation optical system is considered as a whole, the relationship of the relative position between the irradiation optical system and the light-receptive optical system is maintained. Therefore, an irradiation position of the irradiation light La with respect to a flow passage 211 can be changed while maintaining the relationship of the relative position between the irradiation light La incident on the flow cell 210 and the light-receptive optical system 240. Therefore, similar to the particle measuring device 100 according to the first embodiment described above, the particle measuring device 200 can also change the position of the observation area M set with respect to the flow passage 211, enabling scanning over a wide area of the flow passage 211.

### Third Embodiment

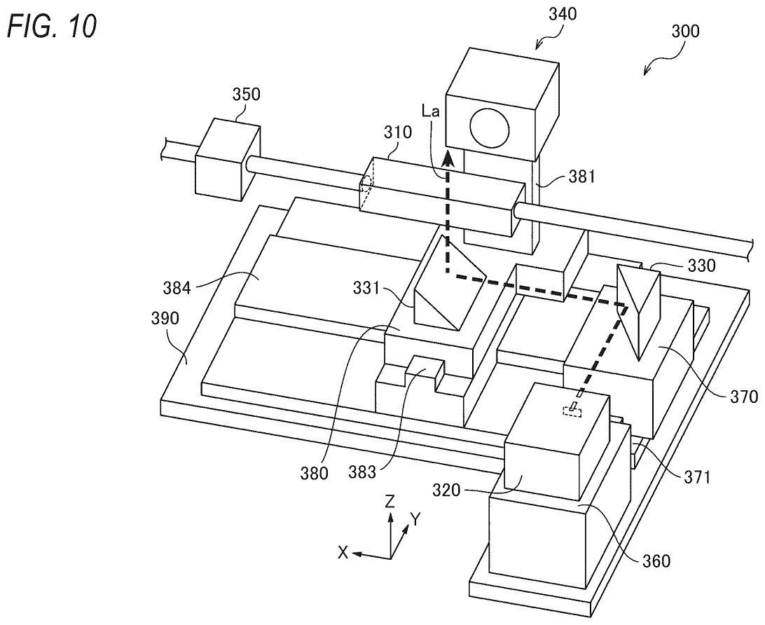

FIG. 10 is a perspective view schematically illustrating a particle measuring device 300 according to a third embodiment.

The particle measuring device 300 includes two mirrors. A light source and one of the mirrors are each arranged on a separate stage, and the other mirror and a light-receptive optical system are arranged on yet another stage. In this point, the particle measuring device 300 is particularly different from the particle measuring device 100 according to the first embodiment and the particle measuring device 200 according to the second embodiment. In relation to this difference, a path of the irradiation light La and a configuration of a slider also differ from those of the particle measuring devices 100 and 200. Descriptions of points common to the first and second embodiments will be omitted.

In the particle measuring device 300, the irradiation light La is emitted from a light source 320 in the Y direction and is reflected by a first mirror 330 in the X direction. The irradiation light La is further reflected by a second mirror 331 toward a flow cell 310, thereby entering the flow cell 310 and irradiating an observation area.

In the particle measuring device 300, the light source 320 is fixed to a first stage 360 that does not move. The first mirror 330 is fixed to a second stage 370 that is movable only in the Y direction. The second mirror 331 and a light-receptive optical system 340 are fixed to a third stage 380 that is movable in the X direction and the Y direction. Accordingly, the particle measuring device 300 includes a Y-axis slider 371 for moving the second stage 370 in the Y direction, as well as a Y-axis slider 383 for moving the third stage 380 in the Y direction and an X-axis slider 384 for moving the third stage 380 in the X direction. The second stage 370 and the third stage 380 may be configured to be moved by a single Y-axis slider.

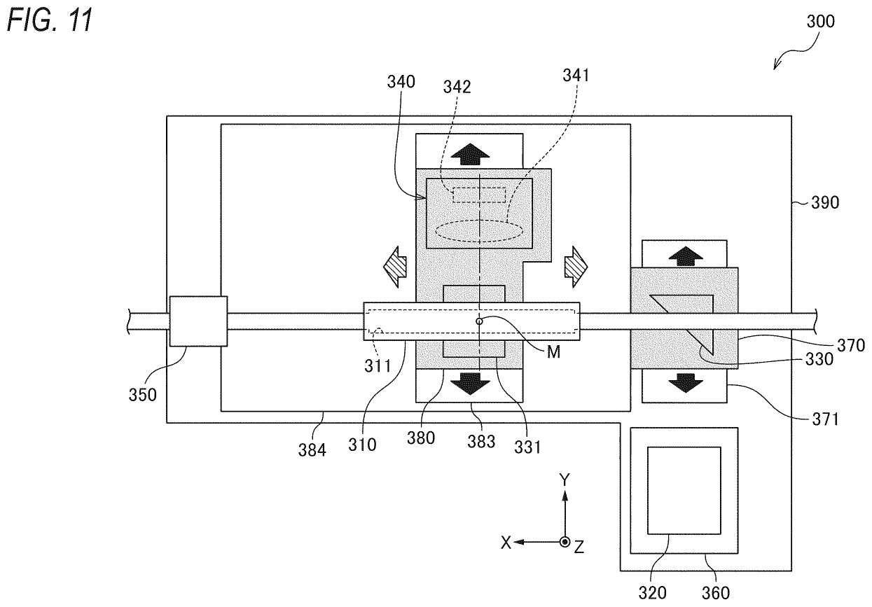

FIG. 11 is a plan view schematically illustrating the particle measuring device 300.

In the particle measuring device 300, the first stage 360 to which the light source 320 is fixed does not move. The second stage 370 to which the first mirror 330 is fixed moves in the Y direction in conjunction with the third stage 380 to which the second mirror 331 and the light-receptive optical system 340 (lens 341, light reception element 342) are fixed. That is, the second stage 370 and the third stage 380 move synchronously in the directions indicated by the black arrows in the figure, and the entire portion shaded to be in mid-color between white and black in the figure moves in the Y direction at the same time.

As the second stage 370 moves in the Y direction and the third stage 380 moves in the Y direction and the X direction, a relative positional relation between the components constituting the irradiation optical system (between the light source 320, the first mirror 330, and the second mirror 331) changes, but if the entire irradiation optical system is considered as a whole, the relationship of the relative position between the irradiation optical system and the light-receptive optical system is maintained. Therefore, an irradiation position of the irradiation light La with respect to a flow passage 311 can be changed while maintaining the relationship of the relative position between the irradiation light La incident on the flow cell 310 and the light-receptive optical system 340. Therefore, similar to the particle measuring device 100 according to the first embodiment and the particle measuring device 200 according to the second embodiment described above, the particle measuring device 300 can also change the position of the observation area M set with respect to the flow passage 311, enabling scanning over a wide area of the flow passage 311.

### Advantages of the Present Invention

As described above, according to the particle measuring device of each of the embodiments described above, the following effects can be achieved.

(1) The irradiation optical system and the light-receptive optical system can be moved in a one-dimensional direction (X direction) or a two-dimensional direction (X direction and Y direction), and the irradiation position of the irradiation light La (the formation position of the observation area) with respect to the flow passage can be changed while maintaining the relationship of the relative position between the irradiation optical system and the light-receptive optical system. This allows scanning to be performed over a wider area in the flow passage as compared with a related particle measuring device, making it possible to perform highly accurate measurement even when the particle distribution in the sample fluid is uneven or when the number of particles is extremely small.

(2) A variable flow-rate mechanism is provided, allowing measurement to be performed in a state where the flow of the sample fluid in the flow passage is stopped (a state where the sample fluid is stored in the flow passage) or in a state where the flow is lowered (a state where the sample fluid flows at a slow speed). By slowing down the flow speed, the sensitivity of light reception can be increased, making it possible to measure smaller particles and reduce the number of particles that go unnoticed, thereby improving measurement accuracy.

(3) Measurement can be performed while moving the position of the observation area (the irradiation position of the irradiation light La) set within the flow passage, and the same area can be measured a plurality of times, which improves the reliability of the measurement results. In addition, when the same area is measured a plurality of times, for example, the measurement can be performed while moving the position of the observation area from one end side (that is, the inlet side) toward the other end side (that is, the outlet side) of the flow passage at an odd-numbered time, and the measurement can be performed while moving the position of the observation area in a direction opposite to that of the odd-numbered time from the other end side to the one end side of the flow passage at an even-numbered time, which combines movement and measurement and minimizes the time spent just on movement, making it possible to shorten the time required for the entire measurement.

(4) Since scanning is performed over a wide area in the flow passage of the flow cell, the time required for the entire measurement is longer than that of a related particle measuring device, but depending on the site, the sample fluid to be measured may not always flow continuously but may instead flow intermittently. In such sites, it is possible to perform measurement by effectively utilizing the time until the next sample fluid arrives. Similar effects can also be expected when the flow speed of the sample fluid is slow or is intentionally slowed down.

(5) By using a light source that emits sheet-shaped irradiation light La (with a cross-sectional shape such as circular or flattened), it is possible to enlarge the observation area M formed by the irradiation of the irradiation light La. In this case, a wide area in the flow passage of the flow cell can be measured with one or several scanning operations, thereby shortening the time required for the entire measurement.

(6) By disposing the irradiation optical system (light source, mirror, and the like) and the light-receptive optical system (lens, light reception element) separately on a plurality of stages, the total weight of the components on one stage can be reduced compared with when all components are disposed on the same stage. This lowers the performance requirements for the sliders needed to move the stages, making it possible to implement the particle measuring device using components with relatively lower performance. As a result, the cost of components related to the stages can be reduced.

The present invention is not limited to the embodiments described above, and can be implemented with various modifications.

In the embodiments described above, the mirror reflects the irradiation light emitted from the light source and causes the irradiation light to enter the flow cell, whereas a lens may be provided between the mirror and the flow cell. This makes it possible to narrow the irradiation light and collect the irradiation light on the observation area of the flow cell with an improved energy density. Alternatively, the irradiation light emitted from the light source may be directly incident on the flow cell without providing a mirror or a lens.

In the embodiments described above, the mirror positioned below the flow cell reflects the irradiation light La directly upwards, causing the irradiation light La to be incident on a bottom surface of the flow cell at approximately a right angle, whereas the incident angle of the irradiation light La is not limited thereto, and the irradiation light La may be incident on the bottom surface at an oblique angle.

In the embodiments described above, scanning is performed on one flow cell, whereas by arranging a plurality of flow cells in an aligned manner in the Y direction, scanning can be performed on a plurality of flow cells.

In the embodiments described above, scanning is performed by changing the position of the observation area M while maintaining the relationship of the relative position between the irradiation optical system and the light-receptive optical system (more precisely, the stages to which the irradiation optical system and the light-receptive optical system are fixed) by moving the irradiation optical system and the light-receptive optical system in the one-dimensional or the two-dimensional direction while fixing the flow cell to the base, but conversely, scanning may also be performed by changing the position of the observation area by moving the flow cell in the one-dimensional or the two-dimensional direction while fixing the irradiation optical system and the light-receptive optical system to the base.

Further, the configurations and numerical values given in the process of describing the particle measuring devices 100, 200, and 300 are merely examples and can be modified as appropriate when implementing the present invention.

The present application is based on a Japanese patent application (Japanese Patent Application No. 2022-184929) filed on Nov. 18, 2022, the contents of which are incorporated herein by reference.

### REFERENCE SIGNS LIST

100: particle measuring device
110: flow cell
120: light source
130: mirror
140: light-receptive optical system
150: flow rate adjustment mechanism
160: stage
163: X-axis slider
164: Y-axis slider
170: base
190: control unit
192: measurement control part (measuring control part)

1. A particle measuring device comprising:
a flow cell having a flow passage into which a sample fluid is introduced;
a variable flow-rate mechanism configured to adjust a flow of the sample fluid in the flow passage;
an irradiation optical system including a light source emitting irradiation light, and configured to irradiate the flow passage with the irradiation light;
a light-receptive optical system configured to receive scattered light generated from particles contained in the sample fluid in an observation area formed in a part of the flow passage by irradiating the flow passage with the irradiation light;
one or more stages on which the irradiation optical system and the light-receptive optical system are disposed;
a movement control portion configured to move the observation area by moving the stage so as to allow scanning of the flow passage; and
a counting portion configured to count the particles by particle size based on intensity of the scattered light.

2. The particle measuring device according to claim 1, wherein
the movement control portion is configured to move the stage while maintaining a relationship of a relative position between the irradiation optical system and the light-receptive optical system.

3. The particle measuring device according to claim 1, wherein
the variable flow-rate mechanism is configured to stop or lower the flow of the sample fluid before starting measurement of the particles.

4. The particle measuring device according to claim 3, further comprising:
a measuring control part configured to control execution of the measurement, and configured to terminate the measurement midway or control the variable flow-rate mechanism to change a flow speed of the sample fluid, depending on a number of particles per unit volume of the sample fluid during the execution of the measurement.

5. The particle measuring device according to claim 1, wherein
the movement control portion is configured to move an irradiation position of the irradiation light with respect to the flow passage along a pattern for moving the irradiation position continuously between a start position and an end position set within the flow passage, and
the light-receptive optical system is configured to receive the scattered light in the observation area formed in a continuous area between the start position and the end position as the irradiation position moves.

6. The particle measuring device according to claim 1, wherein
the movement control portion is configured to move an irradiation position of the irradiation light with respect to the flow passage along a pattern for intermittently moving the irradiation position to a plurality of discontinuous positions set within the flow passage, and
the light-receptive optical system is configured to receive the scattered light in the observation area formed at the plurality of discontinuous positions as the irradiation position moves.

7. The particle measuring device according to claim 5, wherein
the movement control portion is configured to move the irradiation position along the pattern at least once, and
the light-receptive optical system is configured to receive the scattered light at least once in the observation area formed as the irradiation position moves.

8. The particle measuring device according to claim 5, wherein
when moving the irradiation position along the pattern at least once, the movement control portion moves the irradiation position along the pattern in a predetermined direction at an odd-numbered time, and moves the irradiation position along the pattern in a direction opposite to the predetermined direction at an even-numbered time.

9. A particle measuring method of measuring particles using:
a flow cell having a flow passage into which a sample fluid is introduced;
an irradiation optical system including a light source for emitting irradiation light, and configured to irradiate the flow passage with the irradiation light; and
a light-receptive optical system configured to receive scattered light generated from particles contained in the sample fluid in an observation area formed in a part of the flow passage by irradiating the flow passage with the irradiation light,
the particle measuring method comprising:
a movement step of moving an irradiation position of the irradiation light with respect to the flow passage along a predetermined pattern, by moving the irradiation optical system and the light-receptive optical system in a manner corresponding to the predetermined pattern;
a light reception step of receiving the scattered light in the observation area which moves as the irradiation position moves; and
a counting step of counting the particles by particle size based on intensity of the scattered light.

10. The particle measuring device according to claim 6, wherein
the movement control portion is configured to move the irradiation position along the pattern at least once, and
the light-receptive optical system is configured to receive the scattered light at least once in the observation area formed as the irradiation position moves.

11. The particle measuring device according to claim 6, wherein
when moving the irradiation position along the pattern at least once, the movement control portion moves the irradiation position along the pattern in a predetermined direction at an odd-numbered time, and moves the irradiation position along the pattern in a direction opposite to the predetermined direction at an even-numbered time.
